(19) United States
(12) Patent Application Publication
(10) Pub. No.: US 2013/0082932 A1
(43) Pub. Date: Apr. 4, 2013

(54) DYNAMIC DISPLAY KEYBOARD AND A KEY FOR USE IN A DYNAMIC DISPLAY KEYBOARD

(71) Applicants: Jesper Glückstad, Frederiksberg (DK); Finn Pedersen, Roskilde (DK)

(72) Inventors: Jesper Glückstad, Frederiksberg (DK); Finn Pedersen, Roskilde (DK)

(73) Assignee: DANMARKS TEKNISKE UNIVERSITET, Kgs. Lyngby (DK)

(21) Appl. No.: 13/638,902

(22) PCT Filed: Mar. 31, 2011
(86) PCT No.: PCT/EP2011/055068

§ 371 Date: Dec. 7, 2012

(30) Foreign Application Priority Data
Mar. 31, 2010 (EP) 10158763.2
Mar. 31, 2010 (EP) 10158765.7
Mar. 31, 2010 (US) 61341446

(51) Int. Cl. G06F 3/02

(52) U.S. Cl. CPC G06F 3/0202
USPC 345/168

(57) ABSTRACT

The invention relates to a dynamic display keyboard comprising a plurality of key elements, each key element comprises a transmitting part capable of transmitting at least a part of light incident on the transmitting part; a mat comprising a plurality of elevated elements capable of providing a tactile feedback and providing passage of light through the elevated elements; wherein each key element is fixedly connected to at least one respective elevated element; an optical element for each key element; wherein each optical element is adapted to focus an incident light beam onto a transmitting part; at least one display unit capable of providing light to the plurality of transmitting parts via the optical element; and wherein the light provided to a transmitting part defines a visual value of the corresponding key element. In this way, the keyboard is dynamic and further is able to provide a tactile feedback in response to a user action directed towards a key of the keyboard.

The invention relates to a dynamic display keyboard. The invention further relates to a corresponding key.

There is today a large demand on dynamic display keyboards in which the symbols of the keyboard may be dynamically changed such as for example one day to provide Cyrillic characters and the next day Chinese characters.

A problem of the existing dynamic display keyboards is, among other things, their lack of resemblance with traditional keyboards with respect to e.g. size, weight and tactile behaviour of the keys.

It is an object of the present invention to, among other things, solve the abovementioned problem. The abovementioned problem is solved by a dynamic display keyboard comprising a plurality of key elements, a mat, an optical element for each key element and at least one display unit. Furthermore, each key element may comprise a transmitting part for transmitting at least a part of light including a respective first light beam incident on the transmitting part. The mat may comprise a plurality of elevated elements for providing tactile feedback and for providing passage of light including the respective first light beam through the elevated elements. Each key element may be fixedly connected to at least one respective elevated element. Each optical element may be configured to focus an incident light beam including the respective first light beam onto the transmitting part of the respective key element. The at least one display unit may be configured for providing light including e.g. the first light beams to the plurality of transmitting parts via the optical element. A respective first light beam transmitted by a respective transmitting part may define a visual value of the corresponding key element. Furthermore, the mat may be made of a material that is substantially impermeable to water. Furthermore, and the respective connections between each key element and a respective elevated element may substantially impede water from permeating the respective connection. Thus, the optical elements may be at least substantially shielded from water by the mat and the key elements.

Thereby is achieved that the keyboard is dynamic and further is able to provide a tactile feedback in response to a user action directed towards a key of the keyboard. Further, it is ensured that the key value is produced at the top of the key element such as to provide a more clear presentation of the key value to a user.

Furthermore, it is achieved that the keyboard may be less likely to malfunction due to the shielding of the optical elements. It may be of importance that the optical elements are shielded since the optical elements may be sensitive to water and/or dirt and/or dust.

Other embodiments and advantages are provided below in the detailed description, in the claims and in the drawings.

### BRIEF DESCRIPTION OF THE DRAWINGS

FIG. 1a) illustrates an embodiment of a dynamic display keyboard 100 comprising a lens element.

FIG. 1b illustrates an embodiment of a circular cross-sectional form along the X-X axis of a dome element.

FIG. 1c illustrates an embodiment of a square cross-sectional form along the X-X axis of a dome element.

FIG. 2 illustrates an embodiment of a dynamic display keyboard comprising a lens element.

FIG. 3 illustrates an embodiment in which a key element of the dynamic display keyboard is in a depressed state.

FIG. 4 illustrates an embodiment of the dynamic display keyboard further comprising a layer in which the key elements are included.

FIG. 5 illustrates an embodiment in which a key element of the dynamic display keyboard is in a depressed state.

FIG. 6 illustrates an embodiment at least similar to the keyboard of FIG. 1 further comprising a transparent lens-formed layer in each of the key elements.

FIG. 7 illustrates an embodiment of the keyboard of FIG. 1 further comprising a lenslet-array.

FIG. 8 illustrates an embodiment of the keyboard of FIG. 1 further comprising a fiber-optic array comprising a plurality of optical fibers.

FIG. 9 illustrates an embodiment of the keyboard of FIG. 1 wherein the display unit comprises a light-generating unit.

FIG. 10 illustrates an embodiment of the keyboard of FIG. 1 comprising a holographic laser projection (HLP) unit.

FIG. 11 illustrates an embodiment of a key in a dynamic keyboard comprising a scissor-switch.

### DETAILED DESCRIPTION OF THE INVENTION

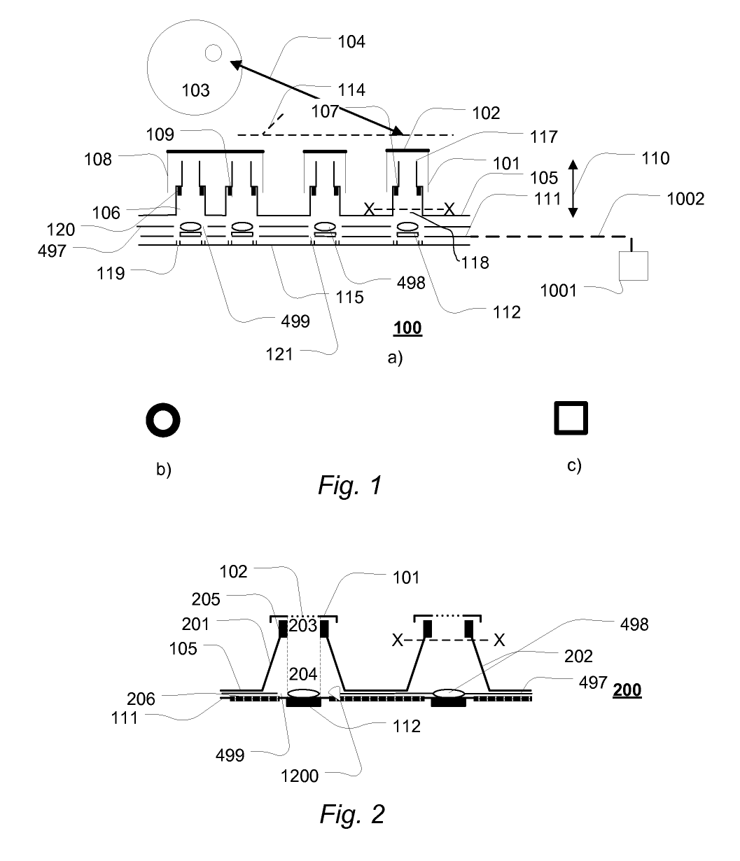

FIG. 1a) illustrates an embodiment of a dynamic display keyboard 100. The dynamic display keyboard comprises a plurality of key elements 101 e.g. a plurality of alpha-numeric keys. Each of the key elements 101 comprises a transmitting part 102 capable of transmitting at least a part of light incident on the transmitting part 102.

In an embodiment, the transmitting part 102 comprises a diffuse-transmission layer. In the above and below, a diffuse-transmission layer is a transmitting layer transmitting electromagnetic radiation in all directions (i.e. at least in substantially all possible directions). Diffuse transmission may be a transmission of light at a boundary such that an incident ray is transmitted at many angles rather than at just one angle. In an embodiment, the electromagnetic radiation transmitted in all directions may be incident electromagnetic radiation e.g. from a group of pixels 112 included in a light generating layer 111 such as an LCD display or the like. In an embodiment, the incident electromagnetic radiation is visible to a human being i.e. in the wavelength range from approximately 380 nm (violet light) to approximately 750 nm (red light).

The transmitting parts 102 may be positioned at the top of the key elements 101 as indicated in FIG. 1a). Thereby, light incident on the transmitting part 102 from a light generating device, such as a group of pixels 112 in a light generating device 111 (such as a flat-panel display e.g. OLED or LCD), may reach a user 103 e.g. via light path 104. The transmitting parts 102 may be connected to the key element 101 via glue, vulcanization, or the like.

In general, for all embodiments of the present invention, fastening by means of glue and/or vulcanization and/or welding may provide a close-fitting or hermetic seal between parts, which seal may be at least substantially waterproof and/or dust-proof.

The dynamic display keyboard 100 may further comprise a mat 105 e.g. made of or comprising an elastic and flexible material such as rubber. The mat 105 may comprise a plurality of elevated elements such as dome elements 106, 107, 109 capable of providing a tactile feedback. The dome elements 106, 107, 109 may be made in the same material as the mat 105. The mat 105 comprising the dome elements 106, 107, 109 may in one embodiment be cast in one piece. The dome elements 106, 107, 109 may be open in both ends 117, 118 i.e. the end facing the transmitting part 102 and the end facing the group of pixels 112. Further, the dome elements 106, 107, 109 may be hollow.

The dome elements 106, 107, 109 may be hollow in order to reduce absorption of light in them. Alternatively, the dome elements 106, 107, 109 may be filled with a transparent and elastic and flexible material such as a transparent polymer or the like. The dome elements 106, 107, 109 may further be open in both ends 117, 118. Thereby, the dome elements 106, 107, 109 enable passage of light from at least a group of pixels 112 from the light generating device 111 to the transmitting part 102.

In an embodiment, the inner surface of the dome elements 106, 107, 109 may be coated with a reflecting material such as e.g. a thin metal layer such as aluminium.

Each key element 101 is physically coupled to at least one dome element 106 as disclosed below. As seen in FIG. 1a), key element 101 is physically connected to one dome element 107, and key element 108 is physically connected to two dome elements 106 and 109. The number of dome elements 106, 107, 109 physically connected to a key element 101, 108 may depend on the size of the key element such that a large key (e.g. a space key) may be connected to a plurality of dome elements and a small key (e.g. a character key) may be connected to a single dome element.

In a computer keyboard, for example, a SHIFT key may be physically connected to two dome elements, an alpha-numeric key may be physically connected to one dome element, and the spacebar may be physically connected to four dome elements.

The terms physically coupled and physically connected are to be understood as the key element may be resting on the dome element and/or it may be glued or vulcanized to the dome element and/or welded to the dome element. Thus, the key element may form a seal with a corresponding elevated element, such as a dome element, which seal is at least substantially impermeable to water and/or dust.

In an embodiment, the dome elements 106, 107, 109 provides control of the dimensions in which the key elements 101, 108 may move in. The dome elements 106, 107, 109 may in an embodiment restrict the direction in which the key elements 101, 108 may move. In an embodiment, the direction to which the key elements may move may be the direction 110 perpendicular to the rubber mat 105 or substantially perpendicular to the rubber mat 105 e.g. 90 degrees +/−5 degrees.

In order to have the dome element deform, an external force provided by a user pressing the associated key element, is required. The dome elements may be made of or may comprise a soft plastic or rubber or any other material capable of deforming along the direction of movement 110 when an external force having a component in the direction of movement 110 is applied to the key element 101. In an embodiment, the dome element 106 may be such as to require a threshold force in the direction of movement 110 before deforming thereby providing a tactile response to a user applying a force to the key element 101 and making the dome element able to sustain the weight of the key element 101 without any substantial deformation in the direction of movement 110 of the key element when an external force is not applied.

Thereby, the dome element 106, 107, 109 is able to provide a tactile feedback in response to a user action e.g. a user pressing the key element.

The key element 101 may be made of or may comprise a material harder than the dome element. For example, the key element 101 may be made of or may comprise melamine resin.

FIG. 1b) illustrates a circular cross-sectional view along the X-X axis of a dome element 106, 107, 109.

FIG. 1c) illustrates a square cross-sectional view along the X-X axis of a dome element 106, 107, 109.

The dynamic display keyboard 100 may further comprise at least one display unit 111. The display unit 111 is adapted to provide light to the plurality of transmitting parts 102. The display unit 111 may comprise a LCD or OLED in which a pixel or a group of pixels 112 of the display are assigned to a key element 101.

In an embodiment of the keyboard of FIG. 1, the keyboard 100 further comprises a layer 497 (also denoted first layer), which layer 497 may be a transparent layer. The layer 497 may be of the same size as the display unit 111. The transparent layer 497 may comprise at least one transparent lens-formed element 498 (also denoted an optical element). The lens-formed element 498 may be made of or may comprise a transparent polymer.

In an embodiment, the transparent layer 497 comprises a plurality of transparent lens-formed elements 498. The transparent layer 497 may comprise a lens-formed element 498 for each group of pixels 112 associated with a key element.

In an embodiment, the transparent layer 497 comprising the lens-formed elements 498 are positioned between the mat 105 and the display unit 111 and such that a lens-formed element 498 is positioned under the respective key element 101 to which the lens-formed element is associated and above the group of pixels 112 associated with the respective key element 101.

The transparent layer 497 may be placed directly on the display unit 111. Additionally, the transparent layer 497 may be glued or otherwise fixed to the display unit 111.

The lens-formed elements 498 are adapted to focus the light emitted from the display unit 111 onto the transmitting part 102 of the corresponding key element 101.

In an embodiment, at least one of the lens-formed elements 498 may be biconvex lens-formed elements.

In an embodiment, at least one of the lens-formed elements 498 may comprise a Fresnel-lens.

As seen in FIG. 1a), the elastic and flexible mat 105 is positioned above the transparent layer 497 and thus between the plurality of key elements 101, 108 and the transparent layer 497.

In an embodiment, the dynamic display keyboard 100 may additionally comprise a printed circuit board (PCB) 115 comprising a plurality of pads 119 for determining whether a key element 101, 108 has been pressed. The pads may in an embodiment be made of or may comprise carbon e.g. an electrically conducting carbon.

In an embodiment, the PCB is positioned below the display unit 111 and in this embodiment, holes/openings 121 in the display unit 111 and holes/openings 499 in the transparent layer 497 are made such that when a key element 101 is depressed, a conductive element 120 connected to the dome element 107 associated with the key element 101 passes through the opening 499 in the transparent layer 497 and through the opening 121 in the display unit 111 in the light generating layer 111 and is brought into contact with the first and second pad parts thereby short circuiting the first and second pad parts of at least one pad 119, thereby enabling detection of the depressed key element 101.

In an alternative embodiment, the PCB is made in a transparent material such as a transparent polymer and the PCB is positioned between the display unit 111 and the transparent layer 497. In this embodiment, holes/openings 499 are made in the transparent layer 497 such that when a key element 101 is depressed, a conductive element 120 connected to the dome element 107 associated with the key element 101 passes through the opening 499 in the transparent layer 497 and is brought into contact with the first and second pad parts thereby short circuiting the first and second pad parts of at least one pad 119, thereby enabling detection of the depressed key element 101. Alternatively, at least one pad 119 extends permanently through one or more of the holes/openings.

In an embodiment, a processing unit 1001 may be communicatively coupled to the light generating layer 111 via a wireless and/or wired communication link 1002 such as Bluetooth or cable. The processing unit 1001 may determine which characters are to be displayed on which key elements 101 by providing a control signal to the respective group of pixels 112 under the key elements 102. In an embodiment, the processing device 1001 further comprises a power providing unit such as a connection to a power grid and/or a battery.

In an embodiment, the PCB circuit is communicatively coupled to the processing unit 1001 via a wireless and/or wired communication link such as Bluetooth or cable. The value of a detected depressed key element 101 may be transmitted from the PCB circuit to the processing unit 1001 for further processing.

For any of the embodiments of FIG. 1, 2, 4, 6, 7, or 8, the dynamic display keyboard may be communicatively coupled to and/or may comprise a processing device 1001 as disclosed above.

FIG. 2 illustrates an embodiment 200 of a dynamic display keyboard. As in the above embodiment 100, the dynamic display keyboard 200 comprises a key element 101 comprising a transparent part 102. The transparent part 102 may be connected to the key element 201 by gluing, vulcanization, welding or the like.

Further, as described above, the dynamic display keyboard 200 further comprises a mat 105 made of or comprising an elastic and flexible material such as rubber. The rubber mat 105 may comprise a plurality of elevated elements such as dome elements 201, 202 capable of providing a tactile feedback as described above.

Additionally, as described above, the dynamic display keyboard 200 may further comprise a transparent layer 497 comprising a plurality of transparent lens-formed elements 498.

The dome elements 201, 202 of FIG. 2 may comprise a cross-sectional form being trapezium shaped in the plane illustrated in FIG. 2. Further, the cross sectional form of the dome elements 201, 202 may be square-shaped along the X-X plane. As above, the rubber mat 105 are open in both ends 203, 204 such as to enable light to pass the dome element from a light generating device 111 to the transparent part 102.

In this embodiment, the dynamic display keyboard 200 may comprise light generating device 111 in the form of a touch sensitive display utilizing capacitive detection. An electrically insulating layer 206 such as a plastic or rubber may be deposited on the light generating layer with openings corresponding to the groups of pixels 112 defining the values of the key elements 101 and fixators 205 disclosed below. The electrically insulating layer may thus be positioned between the light generating device 111 and the mat 105.

In an embodiment, the electrically insulating layer 206 may be transparent.

In an embodiment, the electrically insulating layer 206 may be comprised in the transparent layer 497 comprising a plurality of transparent lens-formed elements 498 such that the layer 497 constitutes the isolating layer and possibly also the layer comprising the dome element/elevated element. In this embodiment, the transparent layer 497 comprises openings 499 adapted to enable passage of the fixators 205.

In the embodiment of FIG. 2, the rubber mat 105 comprises fixators 205 to which the key elements 101 may be fixated e.g. by gluing, vulcanization, welding or the like. The distance between to opposing inner sides of the fixators 205 may correspond to the size of the transparent part 102 in the respective dimensions of the plane containing the transparent part 102. The fixators 205 may be made of or may comprise a hard plastic or rubber material such as to provide a stable platform on which the key element 101 may be placed.

In an embodiment, the fixators 205 are able to conduct an electric current. For example, the hard plastic or rubber may be doped with a metallic powder such as iron or the like. Alternatively or additionally, the fixators 205 may contain an electric wire providing an electrically closed loop.

In an embodiment, the light generating device 111 is a touch sensitive display with capacitive detection.

In an embodiment, the fixators 205 are separate entities glued or vulcanized or welded to the dome elements 201.

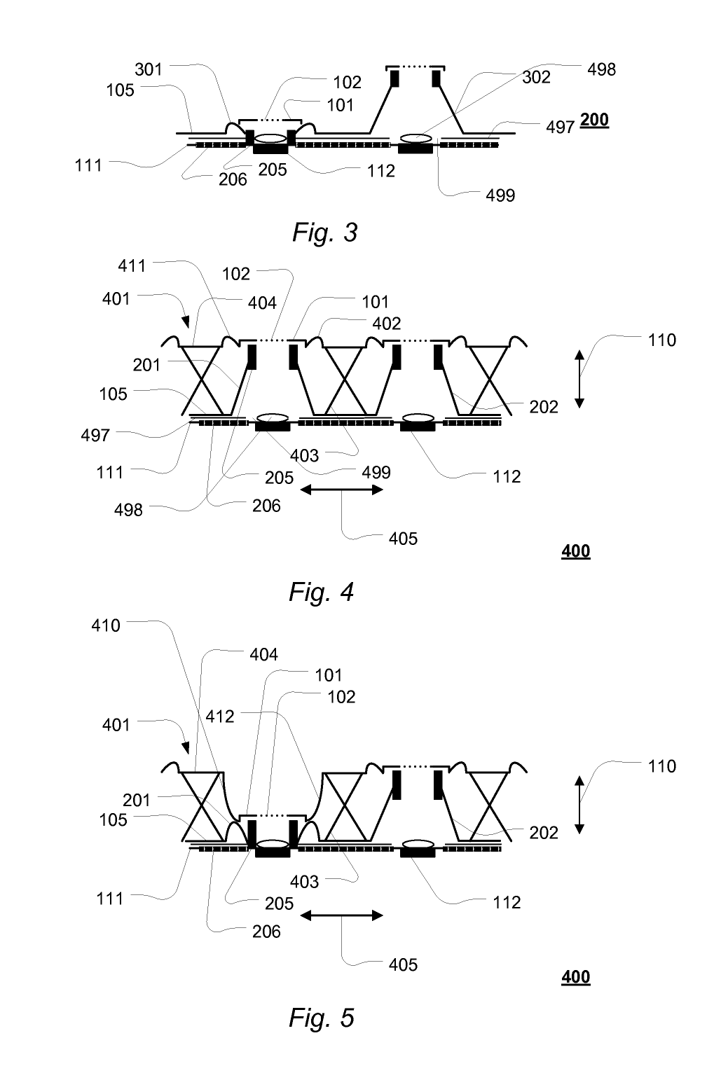

FIG. 3 illustrates an embodiment in which a key element 101 of the dynamic display keyboard 200 comprising electrically conducting fixators is in a depressed state. In this embodiment, the light generating device 111 is a touch sensitive display with capacitive detection. Thereby, when a key element 101 is depressed, the electrically conductive fixators 205 of the key element 101 is brought into contact with the electric field of the capacitive detection and thereby, the touch sensitive display may detect the depressed key element 101. Thereby, the dynamic display keyboard 200 may be used in combination with a touch sensitive display which may provide the value of the key elements 101 by displaying respective key values under respective key elements 101 and the touch display may further provide detection of a depressed key element 101 by detecting changes to the electric field provided by the capacitive detection. 301 and 302 denotes depressed/flexed dome elements 201, 202. The detected depressed key value may be transmitted to the processing unit 1001 for further processing.

FIG. 4 illustrates an embodiment 400 that is at least similiar to the dynamic display keyboard 200. The embodiment 400 comprises a layer 401 (also dented a second layer) in which the key elements 101 are included.

The layer 401 may comprise a collar/ridge 402. The collar/ridge 402 may be made of or may comprise an elastic and flexible material such as rubber. Additionally, the layer 401 may comprise a rigid part 404 made of or comprising a hard and non-flexible plastic.

Between the rigid part 404 and the mat 105 (in the direction 110), supporting elements 403 may be positioned i.e. between the dome elements 201 of the mat 105 (in the direction 406). The supporting elements 403 support the layer 401. The supporting elements 403 may be glued or vulcanized or welded to the rigid part 404 and the mat 105.

The key elements 101 comprises a transparent part 102 i.e. a transparent window. The key elements 101 may be glued or vulcanized or welded to the collar/ridge 402.

In an embodiment, the collar/ridge 402 is made of or comprises a transparent elastic and flexible material.

In an embodiment, the dynamic display keyboard 400 further comprises an electrically insulating layer 206 such as a plastic or rubber deposited on the light generating layer 111 with openings corresponding to the groups of pixels 112 defining the values of the key elements 101 and fixators 205 disclosed above.

Additionally, as described above, the dynamic display keyboard 200 may further comprise a transparent layer 497 comprising a plurality of transparent lens-formed elements 498.

In an embodiment, the electrically insulating layer 206 may be transparent.

In an embodiment, the electrically insulating layer 206 may be comprised in the transparent layer 497 comprising a plurality of transparent lens-formed elements 498 such that the layer 497 constitutes both the isolating layer and the layer comprising the dome element. In this embodiment, the transparent layer 497 comprises openings 499 adapted to enable passage of the fixators 205.

In an embodiment, the light generating layer 111 of the dynamic display keyboard 400 is a touch sensitive display with capacitive detection.

In an embodiment, the height from the top of the light generating layer 111 and to the top of the transparent window 102 is chosen in the range from 2.5 mm to 3.5 mm. In an embodiment, the height from the top of the light generating layer 111 and to the top of the transparent window 102 is chosen in the range from 2 mm to 3 mm. In an embodiment, the height from the top of the light generating layer 111 and to the top of the transparent window 102 is chosen to be 3 mm. Thereby, a large angle of view of the key values associated with a key element for a user is provided by the dynamic display keyboard.

FIG. 5 illustrates an embodiment in which a key element 101 of the dynamic display keyboard 400 is in a depressed state. In the depressed state, the dome element 201 of the depressed key element 101 and the collar/ridge 402 of the depressed key 101 are flexing to provide the tactile feedback of the key element 101.

In an embodiment, the light generating device 111 is a touch sensitive display with capacitive detection. Thereby, when a key element 101 is depressed, the electrically conductive fixators 205 of the key element 101 is brought into contact with the electric field of the capacitive detection and thereby, the touch sensitive display may detect the depressed key element 101. Thereby, the dynamic display keyboard 400 may be used in combination with a touch sensitive display which may provide the value of the key elements 101 by displaying respective key values under respective key elements 101 and the touch display may further provide detection of a depressed key element 101 by detecting changes to the electric field provided by the capacitive detection. Referring to FIGS. 2 and 3, 301 and 302 denotes depressed/flexed dome elements 201, 202. Referring to FIGS. 5, 410 and 412 denotes depressed/flexed collar/ridge elements 402 and 411.

This embodiment (i.e. the embodiment of FIGS. 4 and 5), among other things, provides a keyboard with a layer 401 that is easily cleaned and which prevents dust and other things or fluids from falling in between the dome elements 201. Thus, the layer 401 may provide the above-mentioned shielding effect of the optical element. This may be in combination with the effect caused by the mat or it may be as an alternative.

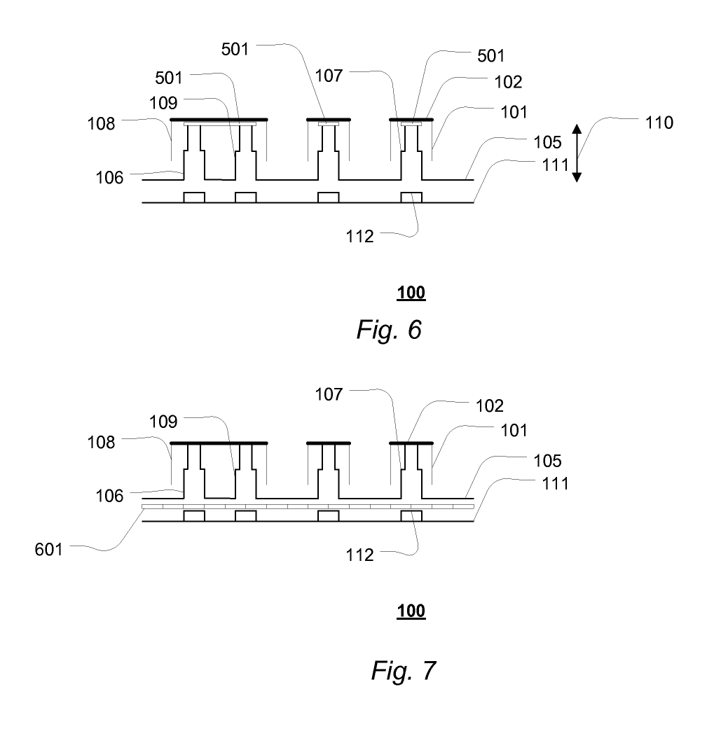

FIG. 6 illustrates an embodiment that is at least similar to the keyboard of FIG. 1. The embodiment of FIG. 6 may comprise all the technical features of FIGS. 1 and/or 2 and/or 4. Instead of the transparent layer 401, the embodiment of FIG. 5 may comprise a transparent lens-formed element 501 in each of the key elements 101. As in FIG. 1, the transmitting part 102 comprises a diffuse-light transmitting layer.

The transparent lens-formed element 501 may be glued to the transmitting part 102 or pressed against the transmitting part 102 by the dome element 107.

The transparent lens-formed element 501 may be plano-convex such as to enable light from the group of pixels 112 to be focussed onto the transmitting part 102 by the transparent lens-formed element 501. In an embodiment, the transparent lens-formed element 501 may be adapted to focus the light incident from the group of pixels 112 onto the top of the transmitting part 102.

Thereby is achieved that the key-information associated with the key element 101 is projected onto the top of the key element 101. Thereby, the angle of view of the key information of the key element 101 is increased. The lens-formed element 501 may be such as to ensure that the image projected to the top of the key element 101 is in focus when the key element is in its un-pressed position.

In an embodiment, the transparent lens-formed layer 501 may comprise a Fresnel-lens.

FIG. 7 illustrates an embodiment of the keyboard of FIG. 1 further comprising a lenslet-array 601 for focussing the light emitted by the display unit 111 onto the respective transmitting parts 102 of the key elements 101. The embodiment of FIG. 7 may comprise all the technical features of FIGS. 1 and/or 2 and/or 4. In this embodiment, the transmitting part 102 comprises a diffuse-light transmitting layer such as a diffuse polymer. The lenslet-array 601 may be contained in a polymer disc or rectangle covering the area of the display unit 111. The lenslet-array 601 may be positioned between the display unit 111 and the elastic and flexible mat 105.

The lenslet-array 601 may be such as to ensure that the image projected to the top of the key element 101 is in focus when the key element is in its un-pressed position.

In an embodiment, the lenslet array 601 may comprise an integral lens array (also known as a fly-eye lens array).

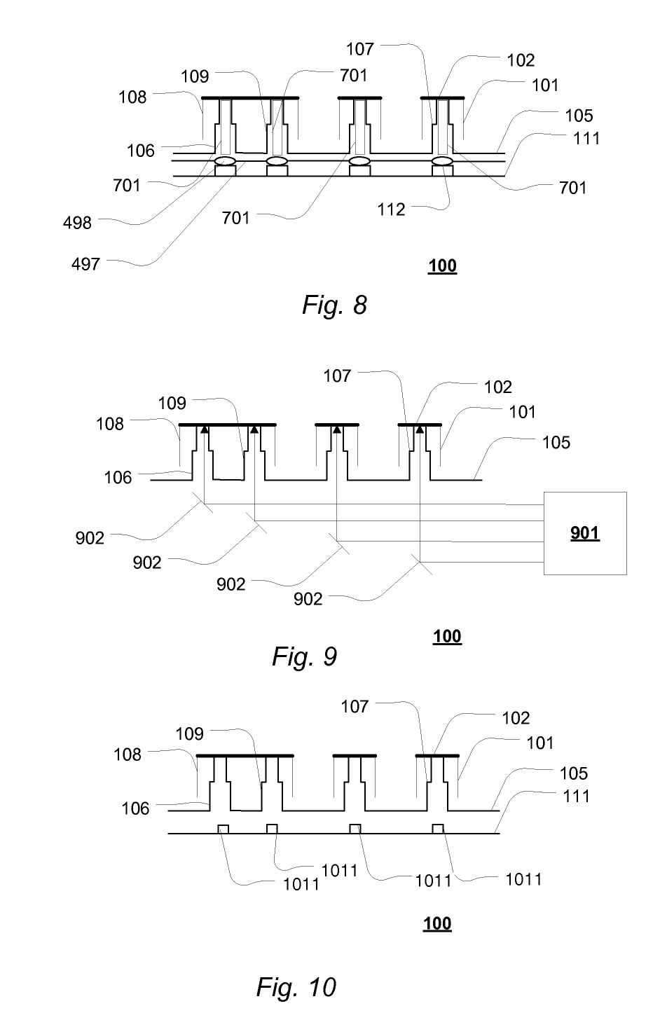

FIG. 8 illustrates an embodiment of the keyboard of FIG. 1 further comprising a fiber-optic array comprising a plurality of optical fibers 701, wherein a first end of an optical fiber is optically coupled to the group of pixels corresponding to a key element 101 via a lens element 498 of a transparent layer 497, and a second end of the optical fiber is optically coupled to the transmitting part 102 of the respective key element 101. An optical coupling may be exemplified by an optical transparent glue or the like. In this embodiment, the transmitting part 102 comprises a diffuse-light transmitting layer such as a diffuse polymer.

In an embodiment, the plurality of fibers are positioned between the transmitting part 102 and the layer 497 such that each lens element 498 thus ensures coupling of light from a respective group of pixels to a associated optical fiber 701. Each optical fiber 701 may thus ensure guidance of light from the lens element 498 associated with a key element 101 to the transmitting part 102 of the key element 101.

In an alternative embodiment, the plurality of fibers are positioned between the transmitting part 102 and elevated elements such that a respective group of pixels couples light directly into an associated optical fiber 701. The optical fiber 701 couples the light onto the transmitting part 102 via the lens 498. Each optical fiber 701 may thus ensure guidance of light from the group of pixels 112 to the respective lens element 498 and from there onto the transmitting part 102 of the key element 101.

FIG. 9 illustrates an embodiment of the keyboard of FIG. 1 wherein the display unit 111 comprises light-generating unit 901 such as a digital micro-mirror device (DMD) or a liquid crystal on silicon unit (LCoS). Further, the keyboard comprises at least one mirror 902 for each key element 101 contained in the keyboard 100. Additionally, the embodiment of FIG. 9 may comprise the mat 105 and the key elements 101 comprising a transmitting part 102.

In this embodiment, the transmitting part 102 comprises a diffuse-light transmitting layer such as a diffuse polymer.

Thereby, the light-generating unit 901 is adapted to provide light to each of the key elements 101 by illuminating the respective mirrors 902 which subsequently reflect the incident light onto the diffuse-light transmitting layer of the key elements 101.

By using a DMD or an LCoS, the weight of the keyboard 101 may be reduced.

FIG. 10 illustrates an embodiment of the keyboard of FIG. 1 comprising a holographic laser projection (HLP) unit. The HLP may contain a class 1 laser product 1011 i.e. an eye-safe RGB laser-diode in the display unit 111. Further, the HLP may contain a holographic generating layer in the transmitting part 102, which holographic generating layer comprises a diffractive structure and provides the alpha-numeric value of the associated key element 101 when illuminated by the class 1 laser product 1011. In an embodiment, the holographic generating layer may be communicatively coupled to the processing unit 1001 via a wireless and/or wired link such as a Bluetooth link or an electrical wire. Thereby, the diffractive structure of each key element 101 may be changed by the processing unit 1001 and thereby provide a dynamic display keyboard.

Additionally, the embodiment of FIG. 10 may comprise the mat 105 and the key elements 101 may comprise a transmitting part 102.

In an embodiment, the keyboard may be included in a computer system via a wired and/or wireless communication link such as an electric cable and/or a Bluetooth link. In this embodiment, the keyboard may comprise a short-range radio receiver and transmitter (e.g. a Bluetooth transmitter and receiver) and the computer system may comprise a similar short-range radio receiver and transmitter. Additionally or alternatively, the keyboard and the computer system may comprise a socket for an electric wire via which the computer system and the keyboard may be connected via an electric wire.

In an embodiment, the dynamic display keyboard of FIG. 1a) or 2 or 4 or 6 may further comprise a photo-detector 1200 (illustrated in FIG. 2) in proximity to each group of pixels associated with a respective key element 101. The photo-detector may be communicatively coupled via Bluetooth or a wire to the processing unit 1001. The photo-detector may detect the intensity of light reaching the photo-detector 1200. When a key element is depressed, the intensity of light detected by the photo-detector decrease due to 1) the object (e.g. a finger) placed on the key element 101 and thus also the transmitting part 102 by the user and 2) the depressed key element may further block for light reaching the photo-detector 1200. Thus, the intensity of light detected by the photo-detector may be used to determine when a key element is depressed. For example, the processing unit may receive intensity-measurements from the photo-detectors each millisecond, and if one or more of the intensities from the respective photo-detectors falls below a predetermined threshold value, then the processing unit 1001 may determine that the one or more key elements 101 associated with the photo-detectors measuring a decrease in intensity, have been depressed.

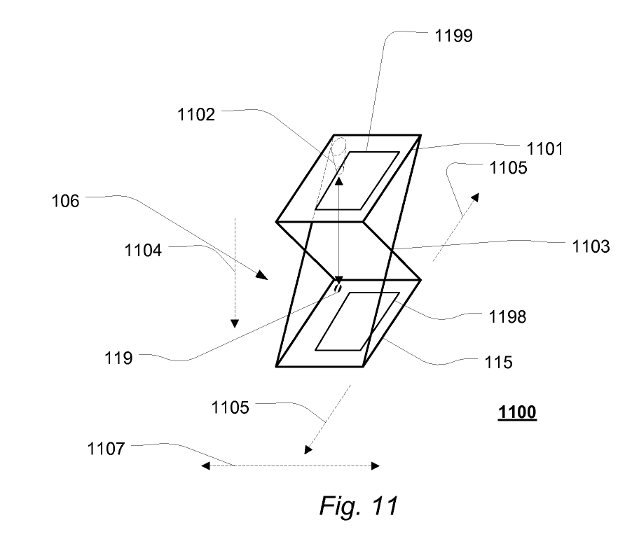

FIG. 11 illustrates an embodiment of a key 1100 in a dynamic keyboard comprising a scissor-switch.

The key 1100 comprises a scissor element 106. The scissor element 106 may comprise a closed top 1101 under which a rod 1102 may be attached in a corner by glue, vulcanization, welding or the like. The rod 1102 may be made of or may comprise a conductive material such as iron doped rubber or the like. The scissor element 106 may further comprise two X-formed structures which may be collapsible around a pivotal point 1103 like an opening scissor. Further, the closed top 1101 may comprise a diffuse transmission part 1199 e.g. a diffuse transmission window. The closed top 1101 may act as a key element which may be depressed by a user. The key 1100 may further comprise a printed circuit board (PCB) 115 comprising a pad arrangement 119 in a corner below the rod 1102.

The key 1100 may further comprise an opening or a transparent window 1198 in the PCB 115. The opening or transparent window 1198 may be adapted to transmit light from a group of pixels (not illustrated) to the diffuse transmission part 1199.

In case of an opening 1198, the light from the group of pixels may be guided through a transparent lens-formed element (not illustrated) focussing the light onto the diffuse transmission part 1198 through the opening 1198.

In case of a transparent window 1198, the light from the group of pixels may be guided through a transparent lens-formed element (not illustrated) focussing the light onto the diffuse transmission part 1198 before passing the window 1198 or alternatively, the transparent window may comprise the transparent lens-formed element.

When a force 1104 is applied to the closed top 1101, the bottom part of the X-structures slides on a rail or track along the direction 1105 thereby reducing the height of the scissor element 106. At a point, the rod 1102 will come into physical contact with the pad arrangement 119 of the PCB 115, whereby electrical contact is made between the two pad parts and the key 1100 may be detected as having been depressed.

The embodiment 1100 may be used in a low profile type keyboard such as known from laptops and the like.

For any embodiment according to the present invention, the plurality of key elements may include at least 27 key elements, such as at least 40 key elements. Each key element may have a surface area of at least 1 cm² and/or a substantially squared surface area measuring at least 1 cm in one direction and 0.5 cm in another direction.

Throughout the description, terms such as “above” and “below” should be understood in a context where the keyboard is situated on a horizontal surface with the key elements facing upwards for operation by a user of the keyboard.

Although some embodiments have been described and illustrated in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

Items
1. A dynamic display keyboard comprising
   a plurality of key elements 101, each key element 101 comprises a transmitting part 102 capable of transmitting at least a part of light incident on the transmitting part;
   a mat 105 comprising a plurality of elevated elements 106, 107, 109, 201, 202 capable of providing a tactile feedback and providing passage of light through the elevated elements;
   wherein each key element 101 is fixedly connected to at least one respective elevated element;
   an optical element 498 for each key element 101; wherein each optical element 498 is adapted to focus an incident light beam onto a transmitting part 102;
   at least one display unit 111 capable of providing light to the plurality of transmitting parts via the optical element 498; and wherein the light provided to a transmitting part defines a visual value of the corresponding key element.
2. A dynamic display keyboard according to item 1, wherein the optical elements 498 is positioned between the transmitting part and the elevated element of the respective key element 101.
3. A dynamic display keyboard according to item 1, wherein the optical elements 498 are contained in a layer 497 positioned between the mat 105 and the at least one display unit 111.
4. A dynamic display keyboard according to any of the preceding items, wherein the transmitting part 102 comprises a diffuse-transmission part and wherein the optical element 498 is adapted to focus the incident light onto the surface of the transmitting part 102 facing away from the display unit 111.
5. A dynamic display keyboard according to any of the preceding items, wherein a part 205 of the elevated element 106, 107, 109, 201, 202 physically contacting the key element 101 is electrically conducting.
6. A dynamic display keyboard according to item 5, wherein the dynamic display keyboard further comprises an electrically insulating layer 206 positioned on the at least one display unit 111 and comprising openings corresponding to the passages of light in the mat 105.
7. A dynamic display keyboard according to item 6 dependent on item 3, wherein the electrically insulating layer 206 is contained in the layer 497 and wherein the openings of the layer 206 are coinciding with the optical elements 498 of the layer 497.
8. A dynamic display keyboard according to any of the preceding items, wherein the dynamic display keyboard further comprises a layer 401 comprising a collar 402 for each key element and wherein each key element 101 comprising a transmitting part 102 is fixedly connected to a respective collar 402.
9. A dynamic display keyboard according to item 6, wherein the dynamic display keyboard further comprises at least one supporting element 403 positioned between the layer 401 and the mat 105.
10. A dynamic display keyboard according to item 3, wherein the optical elements 498 contained in the layer 497 constitutes an integral lens array.
11. A dynamic display keyboard according to any of the preceding items wherein the optical element comprises a Fresnel lens.
12. A dynamic display keyboard according to item 1, further comprising a fiber optic array, wherein each fiber in the fiber optic array is connected in one end to the optical element and the other end to the transmitting part 102.
13. A dynamic display keyboard according to item 1, further comprising a fiber optic array, wherein each fiber in the fiber optic array is connected in one end to the optical element and the other end to the at least one display unit 111.
14. A key for use in a keyboard comprising
   a key element 101 comprising a transmitting part 102 capable of transmitting at least a part of light incident on the transmitting part;
   an elevated elements 106, 107, 109, 201, 202 adapted to provide a tactile feedback when the key is depressed and comprising an opening 113;
   wherein the key element 101 is fixedly connected to the elevated element 106, 107, 109, 201, 202;
   an optical element 498 adapted to focus an incident light beam onto the transmitting part 102;
   at least one display unit 111 capable of providing light to the transmitting part via the optical element 498; and wherein the light provided to the transmitting part 102 defines a visual value of the corresponding key element 101.

1. A dynamic display keyboard, comprising:
a plurality of key elements, each key element comprising a transmitting part for transmitting at least a part of light including a respective first light beam incident on the transmitting part;
a mat comprising a plurality of elevated elements for providing tactile feedback and for providing passage of light including the respective first light beam through the elevated elements; wherein each key element is fixedly connected to at least one respective elevated element;
an optical element for each key element; wherein each optical element is configured to focus an incident light beam including the respective first light beam onto the transmitting part of the respective key element; and
at least one display unit for providing light including the first light beams to the plurality of transmitting parts via the respective optical elements; wherein a respective first light beam transmitted by a respective transmitting part defines a visual value of the corresponding key element,
wherein the mat is made of a material that is substantially impermeable to water and wherein the respective connections between each key element and a respective elevated element substantially impede water from permeating the respective connection, such that the optical elements are at least substantially shielded from water by the mat and the key elements.

2. A dynamic display keyboard according to claim 1, wherein a respective optical element is positioned between a respective transmitting part and a respective elevated element of the respective key element.

3. A dynamic display keyboard according to claim 1, wherein the optical elements are contained in a first layer positioned between the mat and the at least one display unit.

4. A dynamic display keyboard according to claim 1, wherein each transmitting part comprises a diffuse-transmission part and wherein each optical element is configured to focus the incident light onto the surface of a respective transmitting part facing away from the at least one display unit.

5. A dynamic display keyboard according to claim 1, wherein a part of each elevated element physically contacting a respective key element is electrically conducting.

6. A dynamic display keyboard according to claim 5, wherein the dynamic display keyboard comprises an electrically insulating layer positioned on the at least one display unit and having openings corresponding to the passages of light in the mat.

7. A dynamic display keyboard according to claim 16, wherein the electrically insulating layer is contained in the first layer and wherein the openings of the insulating layer are coinciding with the optical elements of the first layer.

8. A dynamic display keyboard according to claim 3 wherein the dynamic display keyboard comprises a second layer comprising a collar for each key element and wherein each key element is fixedly connected to a respective collar.

9. A dynamic display keyboard according to claim 8, wherein the dynamic display keyboard comprises at least one supporting element positioned between the second layer and the mat.

10. A dynamic display keyboard according to claim 9, wherein the layer provides a sealing surface such that dust and/or fluid are prevented from permeating the layer.

11. A dynamic display keyboard according to claim 3, wherein the optical elements contained in the first layer constitutes an integral lens array.

12. A dynamic display keyboard according to claim, wherein the optical element comprises a Fresnel lens.

13. A dynamic display keyboard according to claim 1, further comprising a fiber optic array, wherein each fiber in the fiber optic array is connected in one end to the optical element and the other end to the transmitting part.

14. A dynamic display keyboard according to claim 1, further comprising a fiber optic array, wherein each fiber in the fiber optic array is connected in one end to the optical element and the other end to the at least one display unit.

15. A key for a keyboard, the key comprising:
a key element comprising a transmitting part for transmitting at least a part of light incident on the transmitting part;
an elevated element configured to provide a tactile feedback when the key is depressed and comprising an opening; wherein the key element is fixedly connected to the elevated element;
an optical element configured to focus an incident light beam onto the transmitting part; and
at least one display unit for providing light to the transmitting part via the optical element; and wherein the light provided to the transmitting part defines a visual value of the corresponding key element,
wherein the connection between the key element and the elevated element substantially impede water from permeating the connection, such that the optical element is at least substantially shielded from water by the key.

16. A dynamic display keyboard according to claim 3, wherein a part of each elevated element physically contacting a respective key element is electrically conducting and wherein the dynamic display keyboard includes an electrically insulating layer positioned on the at least one display unit and having openings corresponding to the passages of light in the mat.
